(19) United States
(12) Patent Application Publication
(10) Pub. No.: US 2024/0428704 A1
(43) Pub. Date: Dec. 26, 2024

(54) VISUAL SPEECH RECOGNITION BASED COMMUNICATION TRAINING SYSTEM

(71) Applicant: Technology Innovation Institute - Sole Proprietorship LLC, Masdar City (AE)

(72) Inventors: Elena-Ruxandra Cojocaru, Abu Dhabi (AE); Kebin Wu, Abu Dhabi (AE); Ebtesam Almazrouei, Abu Dhabi (AE)

(73) Assignee: Technology Innovation Institute - Sole Proprietorship LLC, Masdar City (AE)

(21) Appl. No.: 18/745,086

(22) Filed: Jun. 17, 2024

Related U.S. Application Data
(60) Provisional application No. 63/509,626, filed on Jun. 22, 2023.

(51) Int. Cl. G09B 21/06; G09B 5/02; G10L 15/25

(52) U.S. Cl. CPC G09B 21/06; G09B 5/02; G10L 15/25

(57) ABSTRACT

Systems, methods, and computer-readable media for implementing a teaching system focused on the topic of communication via lip-reading using AI-based (automated) visual speech recognition (e.g., VSR) technology, both for developing relevant lesson content and for evaluating user progress. More particularly, the present embodiments can implement AI-based automated lip-reading (also called visual speech recognition or VSR) algorithms in combination with other image processing and machine learning tools to create a teaching system for helping a user learn how to understand conversations through lip-reading and/or how to produce tailored or silent speech so as to be more easily understood through lip-reading.

### CROSS-REFERENCE TO RELATED APPLICATION

This application claims priority to U.S. Provisional Application Ser. No. 63/509,626, filed Jun. 22, 2023, which is incorporated by reference in its entirety.

### TECHNICAL FIELD

This disclosure relates to systems, methods, and computer-readable media for implementing a teaching system focused on the topic of communication via lip-reading using AI-based visual speech recognition models for developing relevant lesson content and for evaluating user progress.

### BACKGROUND

Lip reading is a technique of understanding speech by visually interpreting the movements of the lips, face, and tongue when normal sound is not available. Many individuals, such as those that are hearing-impaired, rely on lip reading for understanding the speech of others. Lip reading also can rely on information provided by the context, knowledge of the language, and any residual hearing.

Visual speech recognition (VSR) or automated lip-reading aims to decode content of speech from a soundless video using various artificial intelligence (AI) techniques. In many cases, a computing node (or series of interconnected computing nodes) can utilize one or more sets of training data to train model(s) (such as a VSR model) to implement a VSR system capable of decoding content of speech in a soundless video.

Source data for training a VSR model can include multiple recorded and/or synthetically generated sources of content (e.g., soundless videos) with corresponding audio speech and/or text subtitles for each source of content. The source data can include sources of content from various groups of individuals (or synthetically generated representations of individuals), such as a group defined by age, gender, cultural background, and/or whether the individual is a native speaker or non-native speaker of a language.

### SUMMARY

The present embodiments relate to systems, methods, and computer-readable media for implementing a teaching system focused on the topic of communication via lip-reading using AI-based (automated) visual speech recognition (e.g., VSR) technology, both for developing relevant lesson content and for evaluating user progress. More particularly, the present embodiments can implement AI-based automated lip-reading (also called visual speech recognition or VSR) algorithms in combination with other image processing and machine learning tools to create a teaching system for helping a user learn how to understand conversations through lip-reading and/or how to produce tailored or silent speech so as to be more easily understood through lip-reading. Lip-reading is not an easy skill, and the present systems and methods can offer a better experience in learning lip-reading.

In a first example embodiment, a computing device (e.g., computing node(s)) for generating lesson content for learning lip-reading skills and modifying the lesson content based on evaluating responses to visual speech recognition prompts is provided. The embodiments as described herein can include obtaining a user profile specific to a user. The user profile can include various data relating to the user, such as any of a user type, an age of the user, one or more interests of the user, and a learning goal of the user. The user types can specify any of users with a hearing-impairment, users with a speech-impairment, users associated with another individual with any of the hearing-impairment and/or the speech-impairment, and users that have an interest in learning lip-reading skills for other communication purposes. The learning goals can include any of understanding how to perform (or improving performance of) lip-reading and learning how to produce (or improve upon) tailored or silent speech (e.g., how to speak, with or without producing audio, respectively, to improve the ability for a listener to lip-read the silent speaker).

The embodiments can include generating at least one training instance. A training instance can include a portion of data used for training the user on either lip-reading or tailored or silent speaking. For example, a training instance can include a video depicting a subject speaking with corresponding audio. Further, the training instance can include corresponding text illustrating the audio or other concepts to illustrate lip-reading or tailored or silent speaking concepts.

Generating at least one training instance can include obtaining a video source depicting a subject speaking and determining, by a visual speech recognition (VSR) model, the content of speech in the video source. The VSR model can derive a ground truth speech content of the video source (e.g., either with or without audio). The training instance can be added to a content database that includes a set of video training instances and corresponding audio output and/or text subtitles. The content database can store a plurality of training instances and other lesson content that can be selected to form a lesson plan.

The embodiments can also include selecting, from the content database, a subset of training instances based at least on the learning goal of the user as specified in the user profile. In some instances, each of the set of training instances in the content database can be processed to derive one or more attributes of each word in each training instance. The attributes of each training instance can be used for the selection of training instances for the lesson content for the user. The one or more attributes can include any of: an ambiguity of each word, a likelihood of each word being understood through lip-reading, a use frequency of each word, an age appropriateness of each word, and/or a relevancy of each word to the one or more interests of the user specified in the user profile, wherein the selection of the subset of the training instances are based on the one or more attributes of each word in each training instance.

In some instances, the subset of training instances can include any of video, audio, text, and animations depicting one or more aspects of lip-reading or silent/tailored speech.

The embodiments can also include generating a set of lesson content for learning lip-reading skills for the user that includes the subset of training instances and a set of evaluation prompts. In some instances, each of the set of evaluation prompts includes a video of a sample subject speaking without audio, and a request for the user to respond by accurately providing corresponding speech content. In some instances, each of the set of evaluation prompts include a string of text with a request for the user to record a video on the user device to silently speak the string of text.

The embodiments can also include providing, to a user device, the lesson content. The user device can be configured to display the subset of training instances on the user device and subsequently display the set of evaluation prompts. The user can interact with the set of evaluation prompts to provide responses based on the prompts. For example, the user can attempt to provide an accurate text response to an evaluation prompt that includes a video of a subject speaking without audio. As another example, the user can record a video to (silently) speak a requested phrase as provided in the evaluation prompt.

The embodiments can also include receiving, from the user device, a set of responses to the set of evaluation prompts. The embodiments can also include deriving, via a VSR-based evaluation model, a score for each set of responses by comparing the responses provided by the user with the predictions of the VSR model to the same set of evaluation prompts.

The embodiments can also include updating any portion of the set of lesson content based on the derived score from each of the set of responses.

In some instances, responsive to determining that the derived score exceeds a threshold, the embodiments can include selecting, from the content database, an advanced subset of training instances based on subset of training instances. The embodiments can also include generating an advanced set of lesson content for the user that includes the advanced subset of training instances and an advanced set of evaluation prompts. The method can also include providing, to the user device, the advanced set of lesson content. The embodiments can also include receiving, from the user device, a second (and successive) set of responses to the advanced set of evaluation prompts. The embodiments can also include deriving, via a second VSR-based evaluation model, a score for each set of responses by comparing the responses provided by the user with the predictions of the VSR model to the same set of evaluation prompts. The embodiments can also include further updating any portion of the set of lesson content based on the derived score for each additional set of responses.

In another example embodiment, a computer-readable storage medium is described. The computer-readable storage medium can contain program instructions for a method being executed by an application, the application comprising code for one or more components that are called by the application during runtime, wherein execution of the program instructions by one or more processors of a computer system causes the one or more processors to perform steps. The embodiments as described herein can include obtaining a user profile specific to a user.

In some instances, the user profile specifies any of a user type, an age of the user, one or more interests of the user, and a learning goal of the user, and wherein the subset of training instances are selected based at least on the learning goal of the user as specified in the user profile. In some instances, the learning goals include any of understanding how to perform lip-reading and learning tailored or silent/tailored speech.

In some instances, the embodiments include analyzing, by a visual speech recognition (VSR) model, at least one training instance by obtaining a video source depicting a subject speaking and determining the speech content of the video source. The embodiments can also include adding at least one training instance to a content database that includes a set of training instances and corresponding audio output and/or text subtitles.

The embodiments can also include selecting, from the content database, a subset of training instances based on the user profile. The embodiments can also include generating a set of lesson content for the user that includes the subset of training instances and a set of evaluation prompts. In some instances, each of the set of evaluation prompts include a video of a sample subject speaking without audio, and a request for the user to respond by accurately providing corresponding speech content. In some instances, each of the set of evaluation prompts include a string of text with a request for the user to record a video on the user device to use tailored or silent speech to reproduce the string of text.

The embodiments can also include providing, to a user device, the set of lesson content. The embodiments can also include receiving, from the user device, a set of responses to the set of evaluation prompts.

The embodiments can also include deriving, via a VSR-based evaluation model, a score for each set of responses by comparing the responses provided by the user with the predictions of the VSR model to the same set of evaluation prompts. The embodiments can also include updating any portion of the set of lesson content based on the derived score for each of the set of responses.

In another example embodiment, a computer-implemented method is provided. The embodiments as described herein can include obtaining a user profile specific to a user. The user profile can specify any of a user type, an age of the user, one or more interests of the user, and a learning goal of the user.

The embodiments can also include generating at least one training instance by obtaining a video source depicting a subject speaking, determining the content of speech by a visual speech recognition (VSR) model, reinforced by audio speech recognition (ASR) if the audio stream of the video source is available, and processing each word of the speech content to derive one or more attributes of each word in each training instance.

In some instances, the user types specify any of users with a hearing-impairment, users with a speech-impairment, users associated with another individual with any of the hearing-impairment and/or the speech-impairment, and users that have an interest in learning lip-reading skills for other communication purposes. In some instances, the learning goals include any of understanding how to perform lip-reading and learning how to use tailored or silent speech.

In some instances, the one or more attributes including any of: an ambiguity of each word, a likelihood of each word being understood, a use frequency of each word, an age appropriateness of each word, and/or a relevancy of each word to the one or more interests of the user specified in the user profile. The selection of the subset of the training instances can be based on the one or more attributes of each word in each training instance.

In some instances, the subset of training instances includes any of video, audio, text, and animations depicting one or more aspects of lip-reading or silent/tailored speech.

The embodiments can also include storing the training instance to a content database that includes a set of training instances and corresponding audio output and/or text subtitles. The embodiments can also include selecting, from the content database, a subset of training instances based at least on the learning goal of the user as specified in the user profile.

The embodiments can also include generating a set of evaluation prompts, wherein each of the set of evaluation prompts include any of a video of a sample subject speaking without audio, and a request for the user to respond by accurately providing corresponding speech content and a string of text with a request for the user to record a video on the user device to silent (or tailored) speak the string of text.

The embodiments can also include providing, to a user device, a set of lesson content for the user that includes the subset of training instances and a set of evaluation prompts.

The embodiments can also include receiving, from the user device, a set of responses to the set of evaluation prompts.

The embodiments can also include deriving, via a VSR-based evaluation model, a score for each of the set of responses by comparing the responses provided by the user with the predictions of the VSR model to the same set of evaluation prompts.

The embodiments can also include updating any portion of the set of lesson content based on the derived score of each of the set of responses.

In some instances, the embodiments can further include, responsive to determining that the derived score exceeds a threshold, selecting, from the content database, an advanced subset of training instances based on subset of training instances. The embodiments can also include generating an advanced set of lesson content for the user that includes the advanced subset of training instances and an advanced set of evaluation prompts.

The embodiments can also include providing, to the user device, the advanced set of lesson content. The embodiments can also include receiving, from the user device, a second set of responses to the advanced set of evaluation prompts. The computer-implemented method can also include deriving, via a second VSR-based evaluation model, a score for each of the second set of responses in comparison with a set of prediction obtained through the VSR model to the same set of evaluation prompts. The embodiments can also include further updating any portion of the set of lesson content based on the derived score for each of the second set of responses.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 illustrates an example method for generating lesson content for lip-reading skills and modifying lesson content based on evaluating responses to visual speech recognition prompts according to an embodiment.

FIG. 2 is an example flow process for implementing a VSR-based training system according to an embodiment.

FIG. 3 illustrates an example flow process for a user profile according to an embodiment.

FIG. 4 is an example flow process for processing training content for a content database and defining lesson content according to an embodiment.

FIG. 5 illustrates an example system for generating lesson content and modifying lesson content based on evaluating responses to visual speech recognition prompts according to an embodiment.

FIG. 6 is a block diagram of a special-purpose computer system according to an embodiment.

### DETAILED DESCRIPTION

Lip-reading generally relates to an ability to detect speech of a subject by reading facial characteristics of the subject without audio. Lip-reading can be an important skill to develop for those who cannot engage in oral communication due to certain physical impairments (e.g., hearing and/or voice related), but it can also benefit the people around them.

Most commonly, many with hearing-impairments are taught sign language, however this may only facilitate communication with interlocutors who also know sign language. Lip-reading, on the other hand, can help hearing-impaired individuals communicate in a much wider context, even in instances when their interlocutors have no prior training. This can improve social communication and help cope with more varied situations.

In many instances, lip-reading can be learned either through in-person courses (limited availability due to scarcity of trained experts) or through traditional digital materials (limited effectiveness).

Visual speech recognition (VSR) or automated lip-reading aims to decode content of speech from a soundless video using various artificial intelligence (AI) and/or machine learning (ML) techniques. Further, training data can be used to train model(s) (such as a VSR model) to implement a VSR system capable of decoding content of speech in a soundless video.

The present embodiments generally relate to a teaching system focused on the topic of communication via lip-reading using AI-based (automated) visual speech recognition (e.g., VSR) technology, both for developing relevant lesson content and for evaluating user progress.

More particularly, the present embodiments can implement AI-based automated lip-reading (also called visual speech recognition or VSR) algorithms in combination with other image processing and machine learning tools to create a teaching system for helping a user learn how to understand conversations through lip-reading and/or how to produce tailored or silent speech so as to be more easily understood through lip-reading. Lip-reading is not an easy skill, and the present systems and methods can offer a better experience in learning lip-reading.

The present embodiments can provide systems and methods for automatically generating a learning database to increase the space of relevant content that can be presented to the user. Further, the content can be correlated with the user profile (e.g., type, age, interests) and (lip-reading related) learning progress, which can make the learning process more effective. Further, visual speech recognition algorithms can be used for the learning performance evaluation, which can provide a more objective reference and reduces the need for expert instructors.

The present embodiments can facilitate learning a skill instead of directly using a communication device, such as a translation interface. Further, having to use a device to interpret speech would be more socially awkward and can raise privacy concerns, as one would need to capture and process audio or visual information from their interlocutor. Lip-reading, on the other hand, can be used as a natural alternative to oral communication. The systems as described herein are not limited by geographic availability, can attract many more users than in-person approaches. The system can also be user-centric, providing a more appropriate and personalized teaching approach, using content specifically generated and selected to improve the user's progress, which can give better results compared to non-AI based methods. In some instances, the embodiments can provide the possibility of scaling the systems to any language in which the VSR algorithm has been trained without the need to employ experts in lip-reading in that language for building new lesson content.

The present embodiments can implement image processing techniques, natural language processing (NLP), clustering techniques, and AI-based visual and audio speech recognition algorithms. The present systems can automatically create a diverse and abundant database of learning material without needing expert lip-readers to produce the material. This can include videos, audios, subtitles and animations, and tags classifying the material with respect to age and other criteria. The system can also select relevant and user-centric lesson material, adapting the structure of the lesson and the pacing. The system can also automatically generate effective visuals to facilitate learning and understanding, to be used as lesson material. Further, for lip-reading understanding, the system can use VSR algorithms to provide a personalized evaluation method to assess the user's understanding through automated lip-reading. For silent speech or tailored speech, the system can use VSR algorithms to provide a personalized evaluation method to assess the user's ability to speak in such a way as to facilitate being understood through lip-reading.

The present embodiments are designed to help various categories of potential users to learn to communicate by lip-reading, focusing on their specific use case. For example, for hearing-impaired individuals, the present systems can teach them how to understand their interlocutors using lip-reading. As another example, for voice-impaired individuals, the present systems can teach them how to use silent speech effectively to be understood through lip-reading. As another example, the present systems can be used by family members and caregivers who work with hearing-impaired individuals, or other interested users to teach them tailored speech, how to speak and select their vocabulary as to increase the chances of being understood through lip-reading or learn understanding through lip-reading based on other interests.

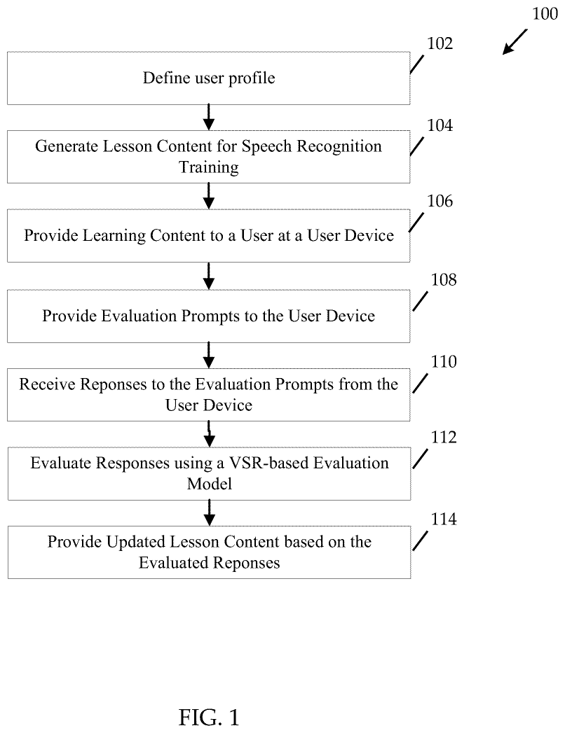

FIG. 1 illustrates an example method 100 for generating lesson content and modifying lesson content based on evaluating responses to visual speech recognition prompts. A computing node (or series of interconnected computing instances) can perform the method as described herein.

At 102, the method can include defining a user profile. A user profile can include one or more characteristics specific to the user. Example characteristics in the user profile can include a user type (e.g., hearing-impaired, speech-impaired), a user age, user interests, and a learning goal of the user (e.g., to learn lip-reading, to learn silent/tailored speech (facial movements to emulate speech without needing audio).

At 104, the method can include generating learning content for speech recognition training. The learning content can include a series of introductory lessons and other lesson content for the user. For example, lesson content can include a series of videos, audio, text, and/or animations depicting concepts relating to lip-reading or silent/tailored speech. The lesson content can be tailored based on the learning goal of the user and/or other features (e.g., an age of the user, interests of the user). Learning content can be selected from a content database storing training instances to train a user as described herein. For example, a VSR-based model can define speech content in a plurality of video samples, and a natural language processing (NLP) model can derive attributes of the defined speech content. The training instances can be selected to be part of the learning content based on the attributes of the defined audio of the video samples.

At 106, the method can include providing the learning content to a user via a user device. The user device can interact with the computing node to obtain the learning content and display the content as described herein. The user can move through the learning content and can view videos, audio, subtitles, animations, etc. In some instances, the user device can provide data relating to the user's progression through the learning content.

At 108, the method can include providing evaluation prompts to the user device. The evaluation prompts can include a prompt for the user to either attempt to accurately identify speech content in a video sample of a subject speaking or provide a video of the user speaking a provided text prompt.

At 110, the method can include receiving responses to the evaluation prompts from the user device. The user device can provide the responses to the computing node for further analysis.

At 112, the method can include evaluating the responses using a VSR-based evaluation model. This can include comparing the provided responses with known ground truths to derive an accuracy of the user in either lip-reading or performing silent/tailored speech. The model can further identify areas of improvement for the user based on the accuracy of the user in providing responses.

At 114, the method can include providing updated learning content based on the evaluated responses. This can include repeating one or more sections of the learning content to the user on the user device. In some instances, advanced lesson content can be generated and provided to the user device, providing advanced concepts relating to lip-reading, for example. In such instances, a second evaluation model can determine accuracy of responses to advanced prompts from the user.

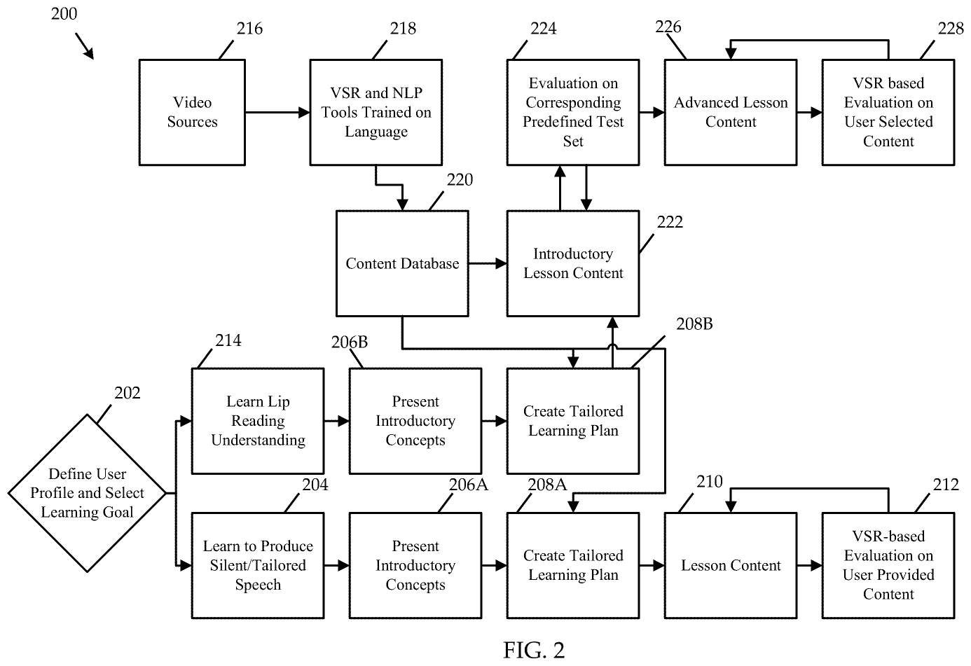

FIG. 2 is an example flow process 200 for implementing a VSR-based training system. The flow process as shown in FIG. 2 illustrates the architecture and relevant articulations of the training system as described herein.

As shown in FIG. 2, a user profile can be defined, identifying what the user wants to learn and profiling the user based on age and interests. After a learning goal (e.g., to learn/improve understanding or speaking) is selected, a series of introductory theoretical slides can be presented. After this, the user can enter a loop of lessons, with each lesson automatically generated using material from the content database, but also the user profile, the content of the previous lesson, and feedback from previous evaluation rounds. The lessons can go from introductory lessons (e.g., focused on single words and highlighting individual mouth movements and other visible aspects like tongue/teeth) to words in context and in sentences of growing complexities. After each lesson, the user can be evaluated on a corresponding video, and the evaluation is provided by comparing the user answers to the prediction from a VSR algorithm on the same video.

At 202, the training system can obtain information for defining a user profile and obtain a selection of a learning goal. The one or more computing instances implementing the training system can interact with a client device (e.g., a mobile phone, laptop computer, table) to define a user profile and obtain a selection of a learning goal.

A user profile can include information relating to the user, such as a user type (e.g., hearing-impaired, voice-impaired individuals, a family member/caretaker of a hearing-impaired or voice-impaired individual), a lip-reading skill level of the user, etc. The user profile can be used to define a main learning goal (e.g., to learn how to lip-read, to learn how to perform silent/tailored speech) for the user. In some instances, the user profile can be further defined based on other information such as user age and interests. The age and interests of the user can influence the vocabulary that is taught and the videos that are used as examples or for evaluation.

At 204, the training system can generate/obtain information to learn to produce silent/tailored speech. For example, a series of introductory lessons can be generated or obtained from a data storage module. The introductory lessons can provide high level information on how to perform silent/tailored speech and identify goals for silent/tailored speech. The introductory lessons can provide insights into various facial features and how movements can enhance silent/tailored speech and make silent/tailored speech easier for another to understand via lip-reading. In some instances, the introductory lessons can be modified based on data in the user profile (e.g., an age of the user, whether the user is hearing-impaired or visually impaired).

At 206A, the training system can present the introductory lessons to the user. The introductory lessons can include any combination of audio, video, and text instructions. In some instances, the lessons can include various animations illustrating facial features. The animations are described in greater detail herein.

At 208A, the training system can create a tailored learning plan. The tailored learning plan can be specific to the user profile and the learning goal for the user. For example, the tailored learning plan can be defined based on a skill level of the user or specifically defined goals of the user to improve one or more aspects of performing silent/tailored speech.

The tailored learning plan can be generated using information included in a content database 220. The content database 220 can store information for generating lessons, such as video sources and corresponding audio and/or text subtitles. The videos can be obtained from one or more video sources (e.g., 216) and can include either recorded video data or synthetically generated videos. A VSR model and/or NLP tools (e.g., 218) can be trained for a language to generate content to be stored in the content database 220.

No speech recognition algorithm has perfect accuracy, however many ASR algorithms are known to have better accuracy than VSR algorithms. For this reason, ASR can play the role of ground truth when text subtitles are not available and also offer a redundancy check to identify problematic samples (e.g., there can be a case when the VSR prediction is very different from the ground truth subtitle, also checking the ASR can help better flag these cases and check them for alignment issues). This check can help minimize any propagation of errors down the pipeline.

The present systems can include three databases, a word database, a sentence-level-video database, and a word-level-video database. The word database can include information such as frequency of use in language, difficulty (based on likelihood of being understood through lip reading), part of speech (extracted from a language dictionary database), length (number of characters), and/or a tag indicating if the language used is also adequate for children (less than 12 years) and/or adolescents (can have one or both tags); it can be assumed that all words are adequate for adults.

The sentence-level-video database can include videos, pre-processed such that only one speaker is shown speaking continuously at an appropriate zoom rate and visibility (remove videos where the area of the head is too small to distinguish facial features), the corresponding (aligned) text subtitles, a time duration, an age range tag, topic/interest tags (can be multiple), also filtered using a face detection quality model (that helps remove cases when the mouth is covered/not visible), and/or filtered to remove toxic speech content.

The word-level-video database can further process the above videos at word level (the system can use either a word aligner or an ASR that assigns word-level subtitles), so that the system can cut the videos into smaller clips at word level. A word aligner can include an algorithm that, by comparing audio and corresponding text subtitles, can produce word-level timestamps, which then help isolate individual words if needed. Finally, clips that contain the same word can be clustered together.

For creating some of the fields mentioned above, various techniques can be employed. For example, exploring the language using text analysis and natural language processing tools can include evaluating use frequency. This can include compiling a large list of subtitles in that language (e.g., with a focus on oral speech), obtaining a list of individual words from that list, and/or creating a histogram computing the frequency of use of each word. This can provide the most used words in that language, where the system can now rank words by frequency. Further, the system can add, for each word, information such as part-of-speech (using a dictionary database and/or a part of speech tagging model) and word length.

Further, the age appropriateness of words can be evaluated at a word level. This can include using a weak filter (three categories: children, adolescents, adults) and assuming all language is adequate for adults, then comparing to word-lists obtained using a pre-curated collection of subtitles from videos targeting children or adolescents, and adding the tag when there is a match. At the sentence level, this can be done for each video's subtitle file using a pre-trained language model that can classify full subtitles according to the same age group labels (children or adolescents). This language model can be trained on a curated collection of text and subtitles considered adequate for children and/or adolescents, then the perplexity of new subtitles can be computed using this language model. Finally, a maximum threshold value for sample perplexity can be imposed to decide if the sample is indeed adequate for the category (children and/or adolescents) that the pre-trained language model targeted.

Further, a relevancy depending on topic/interest category can be specified. A clustering method such as non-negative matrix factorization can be used to cluster together subtitles files based on topic. Then, each cluster can be tagged with a topic or interest category, from which the user can pick their favorites when creating their profile.

Vocabulary can also be qualified using the VSR algorithms as described herein. This can include quantifying ambiguity in visual speech by performing inference of the VSR model on a large collection of videos in the chosen languages, with known ground truth (existing validated subtitles). The results (predictions and ground truths) can be separated at word level and words that are often confused with each other (most likely because they share the same visemes) can be clustered together. These words can be taught together in the lesson plans.

The likelihood of being understood can be quantified by taking results and computing the rate at which each word in the vocabulary list was predicted correctly. The words can then be ranked by difficulty.

As such, the result can include a database of words, ranked increasingly by difficulty (based on likelihood of being understood through visual speech recognition), decreasingly by frequency of use in language, and some complementary information (length, part of speech). Further, words can be selected based on these rankings and introduced gradually in the lessons. There are some parameters to control, such as how many new words are introduced per lesson (this can be increased or decreased depending on user evaluation), and what ratio of parts of speech is used (e.g., teaching more verbs and nouns compared to prepositions and conjunctions).

Once a list of words for the lesson plan is obtained, example videos for those words can be selected from the word-level-video database and/or animations can be generated. Further, a search algorithm in the sentence-level-video database can be used to find examples that contain the group of words from the lesson plan. Filtering can be based on age/interest tags. The results can be ranked according to how many words from the current lesson plan were contained in past lesson plans. The highest-ranking results can be shown, with increasing duration.

At 210, the tailored learning plan can be provided to the user. The lesson content can be provided as video, audio, text, and/or one or more animations. The user can interact with various aspects of the lesson content, such as highlighting audio, repeating a video, interacting with animations, etc.

The lesson content can include one or more evaluations where a user records content of themselves performing silent/tailored speech based on a prompt in the lesson content. At 212, the recorded content is evaluated by a VSR-based evaluation model. For example, the VSR-based evaluation model can identify facial features of the user recorded content and compare the facial features with an evaluation content source to determine an accuracy of the user generated content in producing the requested silent/tailored speech. Further, based on the accuracy of the user generated content, the VSR-based evaluation model can further specify additional learning content targeting areas that the user generated content could use improvement.

The VSR-based evaluation model can evaluate silent/tailored speech based on the user's mouth movement and selected vocabulary. This can be used for the case of users focusing on learning how to adapt their speech to facilitate lip-reading. Many aspects can influence comprehension through lip-reading, such as mouth movements, speed, vocabulary used, which can be learned lesson by lesson. An AI-based VSR algorithm can be used to analyze videos of the user speaking and estimate the likelihood of the user being understood, pointing out the problematic words or sections and guiding future learning plans. This can be a fair and consistent baseline, and the only way to evaluate the user without an expert human lip-reader.

If the user is practicing tailored (voiced) speech rather than silent speech, audio speech recognition (ASR) can be also used to capture the user's intended speech and contrast this with the VSR prediction. This can be used to identify which words were not correctly interpreted by the VSR algorithm and is preferable to forcing the user to manually input the content of their speech.

The training system can also be used to teach or improve lip-reading. At 214, the training system can learn lip-reading understanding. This can include generating/obtaining introductory lessons or other training information relating to lip-reading. For example, the introductory lessons can provide goals of lip-reading, those that can benefit from lip-reading, and major concepts relating to performing lip-reading at a high level.

At 206B, the training system can present the introductory concepts. The introductory concepts can include video/audio/text lessons provided to a user device. The user, via user device, can review and interact with the introductory lessons as described herein.

At 208B, a tailored learning plan can be created for the user. The tailored learning plan can be based on the user profile and the learning goal of the user using content included in the content database 220. For example, the tailored learning plan can include a series of video sources for training specific concepts of lip-reading (e.g., basic speech, sentence structure, speech pacing, advanced enunciations).

The training system can create relevant lesson structure, pacing, and material. The system can use text analysis tools and NLP (Natural Language Processing) to analyze the language and find most frequently used words and classify words according to age appropriateness or based on interest categories. For such classifications, clustering techniques such as Non-Negative Matrix Factorization can be used.

Further, AI-based visual speech recognition methods can be used to evaluate vocabulary groups previously selected in the language of interest and identify words that are less ambiguous and have a high likelihood of being understood through lip-reading. The results can be validated based on VSR and avoid the propagation of errors in our content database. For instance, video subtitles can be used when available and/or ASR, which can have a higher accuracy compared to VSR. These results can be used to structure and pace the lessons, based on word use frequency, user age and interests, and focus on low ambiguity words that are likely to be understood. Example videos can be generated to illustrate the words that are to be learned, isolated and/or in context, using sentences. The sentences can be further filtered to match user age/interests and be appropriate. In some instances, such filters can include text toxicity filters. Such methods can allow to identify a large and relevant vocabulary space and have video footage illustrating it.

Further in some instances, the system can create relevant visuals to facilitate learning. For instance, image processing techniques (such as face detection and landmark detection) can be used to detect and track the mouth landmarks in videos. The system can further identify several speakers pronouncing the same word and/or provide an animated face-free representation of the mouth movements obtained by averaging across multiple individuals producing the same word from available datasets. The system can also emphasize the specific movements made when pronouncing a word being learned, highlight relevant movements of the lips and possibly the tongue when pronouncing different words, and illustrate the pronunciation of the words at different speeds.

The tailored learning plan can be provided to the user as part of introductory lesson content 222. After performing the introductory lesson content, a first evaluation (e.g., 224) can be provided based on a predefined test set. The test set can include a series of video sources of an individual speaking (e.g., either natural or synthetically generated) with known audio of the speaker. The user can attempt to correctly identify the speech in each of the series of video sources. Based on the evaluation of the user for the test set, various parts of the introductory lesson content 222 can be replayed, or the advanced lesson content 226 can be provided.

In some instances, the lesson plans can include both word-level example videos and word-level animations. The animations can bring added value, as they present an averaged-out and more schematic way to visually say a word, which can help people retain the information more easily. The advantage of animations is that they are not hindered by personal style, accent and other particularities that can be found in real videos. Animations can also be slowed down and can have helping arrows and contours to draw the attention of the user to the relevant information in each frame. The animations can provide additional clarity on lesson content compared to the approach of only using real video recordings.

The present embodiments can also provide feedback to users through VSR. A score can be generated based on evaluating responses from a user. For instance, a soundless video can be shown as a training instance, and the user's input can be compared with a ground truth (e.g., known text subtitles) using one or more metrics. The metric can include a word error rate (WER), which can penalize wrong words, missed words, and extra words.

However, lip reading is a difficult task, and many experts have variable and limited accuracy in scoring an accuracy in lip reading. The present embodiment can use a prediction of the VSR algorithm as the basis for comparing with the user's input. VSR evaluation is automatic and can be more accurate than the average human expert in lip-reading. Further, any possible bias/error of the VSR algorithm can be corrected by also comparing the user's prediction to an ASR prediction and the ground truth (text subtitle), when available. For example, if the user identified a specific word correctly and the VSR algorithm did not (compared to ASR or ground truth), the score can be corrected in favor of the user. In some instances, the evaluations can be in the order of VSR, ASR, and ground truth.

As an illustrative example, a first step can include comparing a received response to training instances with a VSR predicted result and the ground truth of the training instances. In an example, the ground truth is a sequence of the words “A B C D E F G H” (each letter symbolizes a word). The VSR prediction could be “A X C Z E F G H” and the user provided responses could be “A B S D C F G W”, where A, F, and G match the VSR prediction. As the score uses the VSR prediction as an initial basis, this leads to an intermediate score of 37.5%.

In this example, the provided responses could be further compared with an ASR prediction, while only increasing the score if more matches are found. For example, the ASR prediction could include “A B C Z E F G H,” and the provided responses can include “A B S D C F G W.” In this step, the term “B” is a match in both the ASR result and the provided responses, bringing the intermediate score to 50%.

Further, the provided responses can be compared with the ground truth if available, only increasing the score if more matches are found. For instance, the ground truth in the previous example was “A B C D E F G H, and the provided responses were “A B S D C F G W”. In this step, the term “D” is a match in both the ground truth and the provided responses, bringing the final score to 62.5%.

In some instances, the scoring algorithm can be more complex than a direct comparison, for example it could include a weighting scheme in which some words are worth more than others. For example, correctly identified longer words are worth more in the final score compared to shorter words. As another example, the weighing scheme could penalize less in the case of incorrect word order, such as when the user correctly identifies two words but inverts their order. Further, the system can inform the user which words were identified correctly. Then the system can inform the user which words included in previous lessons were not identified, as such words should be further reinforced. The system can isolate these words in the evaluation video and replay them. Then, the system can show more video examples and animations of these words to clarify, side by side with the evaluation video.

The VSR algorithms can provide an automatic and consistent way to evaluate responses provided by users in response to provided training instances. In the case of visual speech production, this may be the only automated option to evaluate the user. In the case of lip reading, one can also rely on ground truth or ASR, but VSR can offer a more consistent benchmark.

Further, once evaluation results are obtained, the present embodiments can implement a user-centric approach by identifying learned words that were not correctly understood/spoken, and reinforce those words in following lessons. The approach can also initially use a simple spacing algorithm to include already learned words in future examples or evaluation videos to reinforce learning. Further, once enough data is accumulated from an existing user, machine learning-based algorithms can be used to better predict which words are more difficult to learn or more likely to be forgotten and adapt learning plans using this information.

In some instances, the system can personalize the progress evaluation for lip-reading understanding. For example, evaluation videos can be selected following the content of the lesson and the user profile, with increasing difficulty, to consolidate knowledge. In an initial learning stage, evaluation can be on pre-selected single word videos, which can be a matter to check the user's answer against the known ground truth. In an advanced stage, when using words in sentences, in different contexts, or using new videos, to evaluate the user's progress the software can compare the user generated transcripts to predictions from an AI-based VSR algorithm. This can give the option of using evaluation videos that are not even part of the software database. The video could be downloaded by the user from an internet source or filmed directly by the user and their family, which could help increase the interaction with the user and personalize the learning process.

Another aspect of using VSR as an evaluation tool is that it can provide a fair and consistent baseline for evaluation. The results of a VSR algorithm can be a fair benchmark compared with using subtitles or ASR. In some instances, to check for possible errors in the VSR algorithm, the user prediction may not only be compared to the VSR prediction, but also to ASR predictions and subtitles (ground truth) if available. Each word in the user's answer can be first compared to VSR for matches. Words that do not match VSR will also be compared to ASR and ground truth and considered valid if they match, as it is theoretically possible that the user can correctly identify a word that the VSR algorithm mislabeled.

Advanced lesson content 226 can include more difficult or nuances aspects of lip-reading, such as to identify difficult to understand words, phrases, etc., or to use contextual clues to accurately lip-read various words, for example. The advanced lesson content 226 can include video sources, audio, text, and/or animations to illustrate the concepts to the user.

The advanced lesson content can include advanced evaluation content for the user to respond. For example, the evaluation content can include subjects speaking without audio, and the user may attempt to correctly specify the audio being spoken. At 228, the VSR-based evaluation model can determine an accuracy of the responses provided by the user. In response, either all or a portion of the advanced lesson content 226 can be provided or a report illustrating the accuracy (and any inaccuracies) of the responses can be provided. In some instances, a score can be generated based on an accuracy of the user responses for the evaluation.

As described above, a user profile can be generated for a user. The user profile can include various characteristics relating to the user, such as a user type (e.g., hearing-impaired, voice-impaired, family member/caretaker for a hearing-impaired and/or voice-impaired individual), a user age, user interests, and learning goals of the user.

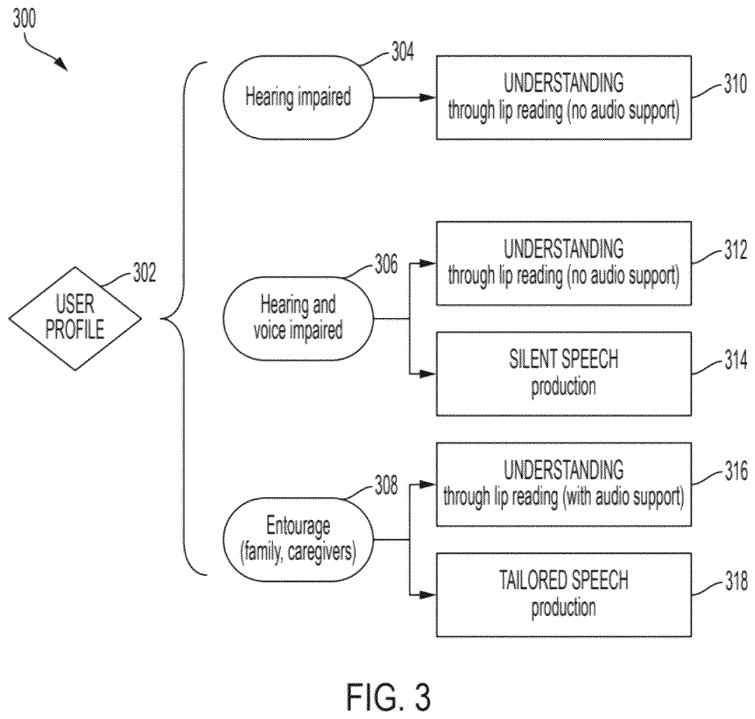

FIG. 3 illustrates an example flow process 300 for a user profile 302. As shown in FIG. 3, the user profile 302 can be defined based at least on a user type. Example user types can include hearing-impaired users 304, voice-impaired (and hearing-impaired) users 306, family member/caretaker for a hearing-impaired and/or voice-impaired individual 308, etc. A type of lesson content for the user can be determined based on this user type and/or other user profile data (e.g., a learning goal).

For example, as shown in FIG. 3, users that are hearing-impaired 304 can have a learning goal for understanding speech through lip-reading 310. Further, users that are hearing-impaired and/or voice-impaired 306 can have a learning goal for understanding speech through lip-reading 312 or silent/tailored speech production 314. Users that are an entourage (e.g., family members, caretakers) of a hearing-impaired and/or voice-impaired individual 308 can have a learning goal for understanding speech through lip-reading 316 or tailored speech production 318.

Further, as noted above, a content database can be populated with training instances (e.g., videos with corresponding audio and/or text subtitles) and other lesson content for understanding lip-reading or silent/tailored speech. A training system can select learning content for each user based on the learning goals for the user, a skill level of the user, previous lessons completed by the user, etc.

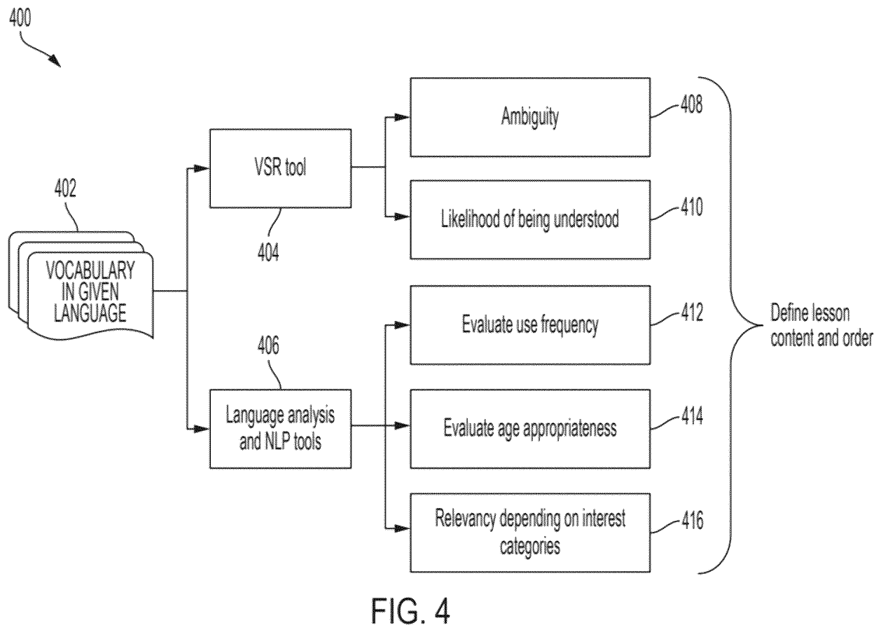

FIG. 4 is an example flow process 400 for processing training content for a content database and defining lesson content. As shown in FIG. 4, a vocabulary store 402 can be maintained for any of a variety of languages. While the English language is used as an illustrative example, the present embodiments are not limited to the English language.

Further, a VSR tool can be used to process obtained video sources and determine corresponding speech content using one or more visual speech recognition techniques. For example, a VSR tool 404 can specify an ambiguity 408 and a likelihood of being understood 410 of each video source. A difficulty of performing lip-reading can be determined based on the ambiguity and the likelihood of being understood for each video source.

Further, various language analysis and NLP tools 406 can be used to parse the derived audio from the video sources and derive further insights into the language. The language analysis and NLP tools 406 can determine a use frequency 412, age appropriateness 414, and/or a relevancy to various interest categories 416 for the audio in each video source. Such insights can be used to define lesson content and an order of presenting lesson content to a user. The selected lesson content (e.g., training instances selected for the user) can be stored for the user such that previous lesson content is stored for the user.

In a first example embodiment, a performed by a computing device (e.g., computing node(s) 602 for generating lesson content and modifying lesson content based on evaluating responses to visual speech recognition prompts is provided. The method can include obtaining a user profile specific to a user. The user profile can include various data relating to the user, such as any of: a user type, an age of the user, one or more interests of the user, and a learning goal of the user. The user types can specify any of users with a hearing-impairment, users with a speech-impairment, and users associated with another individual with any of the hearing-impairment and/or the speech-impairment. The learning goals can include any of understanding how to perform (or improving performance of) lip-reading and learning how to (or improve upon) silent/tailored speak (e.g., how to speak without producing audio to improve an ability for a listener to lip-read the silent/tailored speaker).

The method can include generating at least one training instance. A training instance can include a portion of data used for training the user on either lip-reading or silent/tailored speaking. For example, a training instance can include a video depicting a subject speaking with corresponding audio and/or text subtitle. Further, the training instance can include corresponding text illustrating the audio or other concepts to illustrate lip-reading or silent/tailored speaking concepts.

Generating the at least one training instance can include obtaining a video source depicting a subject speaking and determining, by a visual speech recognition (VSR) model, an audio output of the video source. The VSR model can derive a ground truth speech content of the video source (e.g., either with or without audio). The at least one training instance can be added to a content database that includes a set of training instances and corresponding audio output and/or text subtitles. The content database can store a plurality of training instances and other lesson content that can be selected to form lesson content.

The method can also include selecting, from the content database, a subset of training instances based at least on the learning goal of the user as specified in the user profile. In some instances, each of the set of training instances in the content database can be processed to derive one or more attributes of each word in each training instance. The attributes of each training instance can be used for selection of training instances for the lesson content for the user. The one or more attributes can include any of: an ambiguity of each word, a likelihood of each word being understood, a use frequency of each word, an age appropriateness of each word, and/or a relevancy of each word to the one or more interests of the user specified in the user profile, wherein the selection of the subset of the training instances are based on the one or more attributes of each word in each training instance.

In some instances, the subset of training instances can include any of video, audio, text, and animations depicting one or more aspects of lip-reading or silent/tailored speech.

The method can also include generating a set of lesson content for the user that includes the subset of training instances and a set of evaluation prompts. In some instances, each of the set of evaluation prompts includes a string of text with a request for the user to record a video on the user device to silently speak the string of text. In some instances, each of the set of evaluation prompts include a video of a sample subject speaking without audio, and a request for the user to respond by accurately providing corresponding speech content.

The method can also include providing, to a user device, the set of lesson content for learning lip-reading skills. The user device can be configured to display the subset of training instances on the user device and subsequently display the set of evaluation prompts. The user can interact with the set of evaluation prompts to provide responses based on the prompts. For example, the user can attempt to provide an accurate text response to an evaluation prompt that includes a video of a subject speaking without audio. As another example, the user can record a video to silent speak a requested phrase as provided in the evaluation prompt.

The method can also include receiving, from the user device, a set of responses to the set of evaluation prompts. The method can also include deriving, via a VSR-based evaluation model, an accuracy of each of the set of responses in comparison with a set of known responses to the set of evaluation prompts.

The method can also include updating any portion of the set of lesson content based on the derived accuracy of each of the set of responses.

In some instances, responsive to determining that the derived accuracy exceeds a threshold, the method can include selecting, from the content database, an advanced subset of training instances (e.g., 226) based on subset of training instances. The method can also include generating an advanced set of lesson content for the user that includes the advanced subset of training instances and an advanced set of evaluation prompts. The method can also include providing, to the user device, the advanced set of lesson content. The method can also include receiving, from the user device, a second set of responses to the advanced set of evaluation prompts. The method can also include deriving, via a second VSR-based evaluation model (e.g., 228), an accuracy of each of the second set of responses in comparison with a set of known responses to the set of evaluation prompts. The method can also include further updating any portion of the set of lesson content based on the derived accuracy of each of the second set of responses.

In another example embodiment, a computer-readable storage medium is described. The computer-readable storage medium can contain program instructions for a method being executed by an application, the application comprising code for one or more components that are called by the application during runtime, wherein execution of the program instructions by one or more processors of a computer system causes the one or more processors to perform steps. The steps can include obtaining a user profile specific to a user.

In some instances, the user profile specifies any of a user type, an age of the user, one or more interests of the user, and a learning goal of the user, and wherein the subset of training instances are selected based at least on the learning goal of the user as specified in the user profile. In some instances, the learning goals include any of understanding how to perform lip-reading and learning how to silent speak.

In some instances, the instructions further cause the one or more processors to perform steps comprising: generating, by a visual speech recognition (VSR) model, at least one training instance by obtaining a video source depicting a subject speaking and determining an audio output of the video source. The steps can also include adding the training instance to a content database that includes a set of training instances and corresponding audio output and/or text subtitles.

The steps can also include selecting, from the content database, a subset of training instances based on the user profile. The steps can also include generating a set of lesson content for the user that includes the subset of training instances and a set of evaluation prompts. In some instances, each of the set of evaluation prompts include a string of text with a request for the user to record a video on the user device to silent speak the string of text. In some instances, each of the set of evaluation prompts include a video of a sample subject speaking without audio, and a request for the user to respond by accurately providing corresponding speech content.

The steps can also include providing, to a user device, the set of lesson content. The steps can also include receiving, from the user device, a set of responses to the set of evaluation prompts.

The steps can also include deriving, via a VSR-based evaluation model, an accuracy of each of the set of responses in comparison with a set of known responses to the set of evaluation prompts. The steps can also include updating any portion of the set of lesson content based on the derived accuracy of each of the set of responses.

In another example embodiment, a computer-implemented method is provided. The computer-implemented method can include obtaining a user profile specific to a user. The user profile can specify any of a user type, an age of the user, one or more interests of the user, and a learning goal of the user.

The computer-implemented method can also include generating at least one training instance by obtaining a video source depicting a subject speaking, determining by a visual speech recognition (VSR) model, an audio output of the video source and processing each word of the audio output to derive one or more attributes of each word in each training instance.

In some instances, the user types specify any of users with a hearing-impairment, users with a speech-impairment, and users associated with another individual with any of the hearing-impairment and/or the speech-impairment. In some instances, the learning goals include any of understanding how to perform lip-reading and learning how to silent speak.

In some instances, the one or more attributes including any of: an ambiguity of each word, a likelihood of each word being understood, a use frequency of each word, an age appropriateness of each word, and/or a relevancy of each word to the one or more interests of the user specified in the user profile. The selection of the subset of the training instances can be based on one or more attributes of each word in each training instance.

In some instances, the subset of training instances include any of video, audio, text, and animations depicting one or more aspects of lip-reading or silent/tailored speech.

The computer-implemented method can also include storing the training instance to a content database that includes a set of training instances and corresponding audio output and/or text subtitles. The computer-implemented method can also include selecting, from the content database, a subset of training instances based at least on the learning goal of the user as specified in the user profile.

The computer-implemented method can also include generating a set of evaluation prompts, wherein each of the set of evaluation prompts include any of a string of text with a request for the user to record a video on the user device to silent/tailored speak the string of text and a video of a sample subject speaking without audio, and a request for the user to respond by accurately providing corresponding speech content.

The computer-implemented method can also include providing, to a user device, a set of lesson content for the user that includes the subset of training instances and a set of evaluation prompts.

The computer-implemented method can also include receiving, from the user device, a set of responses to the set of evaluation prompts.

The computer-implemented method can also include deriving, via a VSR-based evaluation model, an accuracy of each of the set of responses in comparison with a set of known responses to the set of evaluation prompts.

The computer-implemented method can also include updating any portion of the set of lesson content based on the derived accuracy of each of the set of responses.

In some instances, computer-implemented method can further include, responsive to determining that the derived accuracy exceeds a threshold, selecting, from the content database, an advanced subset of training instances based on subset of training instances. The computer-implemented method can also include generating an advanced set of lesson content for the user that includes the advanced subset of training instances and an advanced set of evaluation prompts.

The computer-implemented method can also include providing, to the user device, the advanced set of lesson content. The computer-implemented method can also include receiving, from the user device, a second set of responses to the advanced set of evaluation prompts. The computer-implemented method can also include deriving, via a second VSR-based evaluation model, an accuracy of each of the second set of responses in comparison with a set of known responses to the set of evaluation prompts. The computer-implemented method can also include further updating any portion of the set of lesson content based on the derived accuracy of each of the second set of responses.

### Computing System Overview

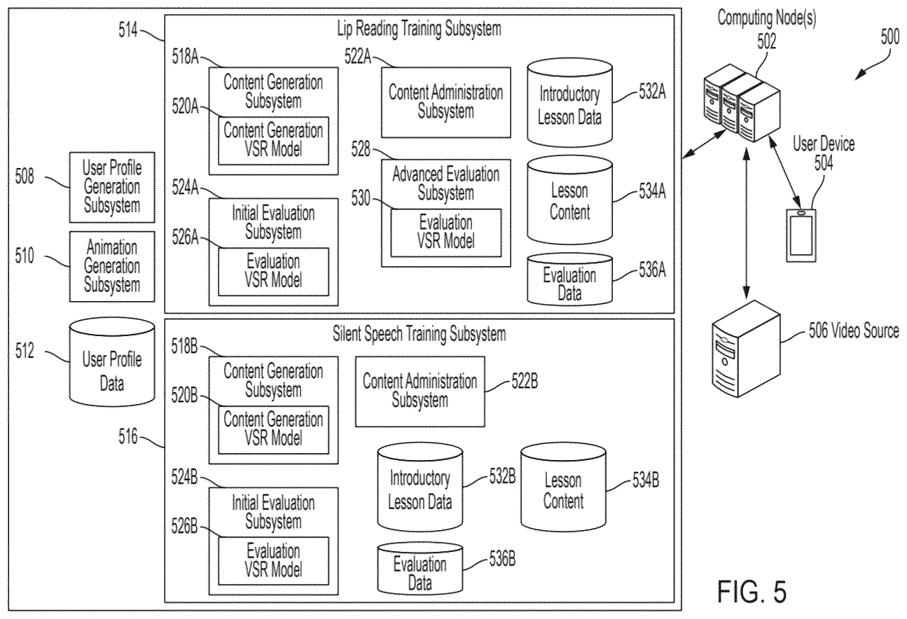

As described above, a computing node (or series of interconnected computing nodes) can identify and perform any of the steps as described herein. FIG. 5 illustrates an example system 500 for generating lesson content and modifying lesson content based on evaluating responses to visual speech recognition prompts.

As shown in FIG. 5, the system 500 can include a computing node (or series of interconnected computing nodes) 502. Further, the computing node 502 can store various data and include subsystems as described herein. The computing node 502 can interact with other devices in the system 500. For example, the computing node 502 can communicate with a user device 504 and one or more video source(s) 506. The user device 504 can include a device associated with a user, such as a mobile phone, computer, tablet, etc. As described in greater detail herein, the user device 504 can interact with the computing node 502 to generate a user profile, obtain lesson content, and provide evaluation responses to the computing node for further evaluation and updating the lesson content for the user.

The video source 506 can include a computing node capable of storing one or more videos. The computing node 502 can obtain videos from the video source 506 and process the videos as described herein.

The computing node 502 can include a user profile generation subsystem 508. The user profile generation subsystem 508 can generate a user profile for each user. The user profile can include various information, such as a user type, learning goals of the user, user age, user interests, etc. In some instances, the user profile can track progress of the lesson content previously interacted with by the user and any evaluation results for the user. The computing node 502 can store user profile data 512. The user profile data 512 can include data relating to the user profile as described herein.

The computing node 502 can also include an animation generation subsystem 510. The animation generation subsystem 510 can generate one or more animations illustrating various facial features or movements. The animations are obtained at word level, using the word-level-video database. A collection of videos illustrating the same word are retrieved from this database. Each video is resampled such that all videos representing the same word have the same number of frames. Each video is then pre-processed such that the facial landmarks in every frame are retrieved and the mouth area is cropped. Each cropped mouth-area video is normalized to have the same width and height, and the facial landmarks composing the mouth area are also normalized using the same normalization parameter. Finally, the position of each facial landmark composing the mouth area is averaged out across all the videos for each frame and the final animation is obtained as a collection of points. Arrows indicating horizontal or lateral movements of specific regions of the mouth can be automatically added to frames based on heuristics referring to the position and speed of the corresponding points. The animations can highlight specific concepts relating to lip-reading or silent/tailored speech for teaching the user. The animations can include a video, a bitmap image (e.g., a Graphics Interchange Format (GIF)), etc.

The computing node 502 can include both a lip-reading training subsystem 514 and a silent/tailored speech training subsystem 516. As described above, based on a user profile and learning goals for the user, the system as described herein can train for either lip-reading (e.g., via lip-reading training subsystem 514) or train for performing silent/tailored speech (e.g., via silent/tailored speech training subsystem 516).

The lip-reading training subsystem 514 can include a content generation subsystem 518A. The content generation subsystem 518A can generate content to be added to a content database. For example, the content can include video obtained from a video source. The video can be processed using a VSR model (e.g., 520A) to derive speech for the video of a subject speaking. Various tools, such as a NLP tool, can process the derived speech to derive attributes (e.g., age appropriateness, use frequency, relevancy to interests) for the audio. Other forms of content can include text-based content, animations, etc. The content saved in the content database can include various content types, and the lessons can be selected from the content in the content database.

The lip-reading training subsystem 514 can also include a content administration subsystem 522A. The content administration subsystem 522A can select a subset of content from the content database to be added to the lesson content for the user. For example, the content administration subsystem 522A can determine a learning goal for the user (e.g., understanding lip-reading, understanding silent speech) and/or determine a skill level of the user. The content administration subsystem 522A can then select content from the content database that illustrates various concepts specific to the learning goal and/or the skill level of the user. For example, various video sources can be selected based on attributes relating to the derived speech in the video, how difficult the speech is to lip-read, etc. The selected lesson content from the content database can be packaged into one or more lessons to be provided to the user device.

The lip-reading training subsystem 514 can also include an initial evaluation subsystem 524A. The initial evaluation subsystem 524A can generate evaluation prompts for evaluating a user. The evaluation prompts can include a series of videos of a subject (e.g., either natural or synthetically generated) speaking. The prompts can request the user to accurately identify the speech spoken by the subject using lip-reading techniques discussed in the lesson content. The user can view the evaluation prompt on the user device and provide a response either in a text format or an audio format.

The initial evaluation subsystem 524A can further obtain the responses from the user device and determine an accuracy of the responses based on known speech of the evaluation prompts (e.g., using evaluation VSR model 526A). The accuracy of the responses (and inaccuracies) can provide insights into areas of competency and areas of improvement for the user. In response, one or more sections of the lesson content can be replayed at the user device to highlight areas of improvement. In some instances, if the accuracy of the responses exceeds a threshold, an advanced set of lesson content can be generated and an advanced evaluation process can be initiated.

The lip-reading training subsystem 514 can also include an advanced evaluation subsystem 528. The advanced evaluation subsystem 528 can generate advanced lesson content that includes content with more advanced concepts than the lesson content provided initially to the user. The advanced lesson content can include video sources that include difficult to understand speech or speed with less frequent usage, which can allow for the user to learn and practice more difficult concepts for lip-reading.

The advanced evaluation subsystem 528 can further generate advanced evaluation prompts, receive responses from the user device, and evaluate the accuracy of the responses (e.g., using evaluation VSR model 530). The advanced evaluation subsystem 528 can further iterate lessons based on the accuracy of the responses to evaluation prompts by the user.

The lip-reading training subsystem 514 can store various information, such as introductory lesson data 532A, lesson content information 534A, and evaluation data 536A. The introductory lesson data 532A can include repositories of introductory lessons relating to lip-reading. The introductory lessons can be added to the lesson content provided to the user. The lesson content information 534A can include lesson content provided to the user. The evaluation data 536A can include evaluation prompts, responses, and derived insights into the responses generated by the initial evaluation subsystem 524A and/or the advanced evaluation subsystem 528 as described herein.

The silent/tailored speech training subsystem 516 can include a content generation subsystem 518B. The content generation subsystem 518B can generate content for silent/tailored speech training lessons (e.g., using content generation VSR model 520B). The generated content can include videos, text, audio, and/or animations as described herein.

The silent/tailored speech training subsystem 516 can also include a content administration subsystem 522B. The content administration subsystem 522B can select content to be added to a lesson for silent/tailored speech. For example, a learning goal and a skill level of the user can be used to determine a type of content to be added to the learning content for the user. The lesson content can be provided to the user device for review by the user as described herein.

The silent/tailored speech training subsystem 516 can also include an initial evaluation subsystem 524B. The initial evaluation subsystem 524B can generate evaluation prompts for silent/tailored speech. The evaluation prompts can include a prompt to speak certain audio using silent/tailored speech. A VSR model can review the responses and determine an ability for the VSR model (e.g., 526B) to accurately identify the speech silently spoken by the user in the video. The accuracy can be based on a confidence the VSR model has in accurately determining the speech of the user in the evaluation prompt response. The lesson content can be updated based on the derived accuracy of the responses provided by the user.

The silent/tailored speech training subsystem 516 can store various information, such as introductory lesson data 532B, lesson content information 534B, and evaluation data 536B.

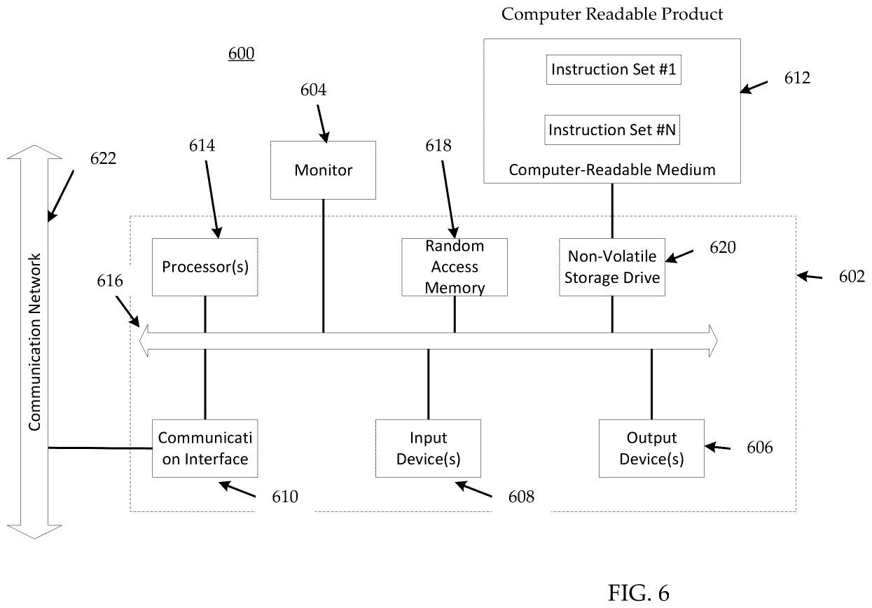

FIG. 6 is a block diagram of a special-purpose computer system 600 according to an embodiment. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 600 comprises a computer 602, a monitor 604 coupled to computer 602, one or more additional user output devices 606 (optional) coupled to computer 602, one or more user input devices 608 (e.g., keyboard, mouse, track ball, touch screen) coupled to computer 602, an optional communications interface 610 coupled to computer 602, and a computer-program product including a tangible computer-readable storage medium 612 in or accessible to computer 602. Instructions stored on computer-readable storage medium 612 may direct system 600 to perform the methods and processes described herein. Computer 602 may include one or more processors 614 that communicate with a number of peripheral devices via a bus subsystem 616. These peripheral devices may include user output device(s) 606, user input device(s) 608, communications interface 610, and a storage subsystem, such as random-access memory (RAM) 618 and non-volatile storage drive 620 (e.g., disk drive, optical drive, solid state drive), which are forms of tangible computer-readable memory.

Computer-readable medium 612 may be loaded into random access memory 618, stored in non-volatile storage drive 620, or otherwise accessible to one or more components of computer 602. Each processor 614 may comprise a microprocessor, such as a microprocessor from Intel® or Advanced Micro Devices, Inc.®, or the like. To support computer-readable medium 612, the computer 602 runs an operating system that handles the communications between computer-readable medium 612 and the above-noted components, as well as the communications between the above-noted components in support of the computer-readable medium 612. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 608 include all possible types of devices and mechanisms to input information to computer system 602. These may include a keyboard, a keypad, a mouse, a scanner, a digital drawing pad, a touch screen incorporated into the display, audio input devices such as voice recognition systems, microphones, and other types of input devices. In various embodiments, user input devices 608 are typically embodied as a computer mouse, a trackball, a track pad, a joystick, wireless remote, a drawing tablet, a voice command system. User input devices 608 typically allow a user to select objects, icons, text and the like that appear on the monitor 604 via a command such as a click of a button or the like. User output devices 606 include all possible types of devices and mechanisms to output information from computer 602. These may include a display (e.g., monitor 604), printers, non-visual displays such as audio output devices, etc.

Communications interface 610 provides an interface to other communication networks and devices and may serve as an interface to receive data from and transmit data to other systems, WANs and/or the Internet, via a wired or wireless communication network 622. In addition, communications interface 610 can include an underwater radio for transmitting and receiving data in an underwater network. Embodiments of communications interface 610 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 610 may be coupled to a computer network, to a FireWire® bus, or the like. In other embodiments, communications interface 610 may be physically integrated on the motherboard of computer 602, and/or may be a software program, or the like.

RAM 618 and non-volatile storage drive 620 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 618 and non-volatile storage drive 620 may be configured to store the basic programming and data constructs that provide the functionality of various embodiments of the present invention, as described above.

Software instruction sets that provide the functionality of the present invention may be stored in computer-readable medium 612, RAM 618, and/or non-volatile storage drive 620. These instruction sets or code may be executed by the processor(s) 614. Computer-readable medium 612, RAM 618, and/or non-volatile storage drive 620 may also provide a repository to store data and data structures used in accordance with the present invention. RAM 618 and non-volatile storage drive 620 may include a number of memories including a main random-access memory (RAM) to store instructions and data during program execution and a read-only memory (ROM) in which fixed instructions are stored. RAM 618 and non-volatile storage drive 620 may include a file storage subsystem providing persistent (non-volatile) storage of program and/or data files. RAM 618 and non-volatile storage drive 620 may also include removable storage systems, such as removable flash memory.

Bus subsystem 616 provides a mechanism to allow the various components and subsystems of computer 602 communicate with each other as intended. Although bus subsystem 616 is shown schematically as a single bus, alternative embodiments of the bus subsystem may utilize multiple busses or communication paths within the computer 602.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine or computer-readable code recorded on a machine or computer-readable medium. In some embodiments, the computer-readable medium may be a non-transitory computer-readable medium. Examples of such a non-transitory computer-readable medium include but are not limited to a read-only memory, a random-access memory, a flash memory, a CDROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method performed by a computing device for generating lesson content for lip-reading skills and modifying the lesson content based on evaluating responses to visual speech recognition prompts, the method comprising:
obtaining a user profile specific to a user, the user profile specifying any of: a user type, an age of the user, one or more interests of the user, and a learning goal of the user;
generating at least one training instance by:
obtaining a video source depicting a subject speaking; and
determining, by a visual speech recognition (VSR) model, the speech content of the video source;
adding the training instance to a content database that includes a set of training instances and corresponding audio output and/or text subtitles;
selecting, from the content database, a subset of training instances based at least on the learning goal of the user as specified in the user profile;
generating a set of lesson content for the user that includes the subset of training instances and a set of evaluation prompts;
providing, to a user device, the set of lesson content, wherein the user device is configured to display the subset of training instances on the user device and subsequently display the set of evaluation prompts;
receiving, from the user device, a set of responses to the set of evaluation prompts;
deriving, via a VSR-based evaluation model, a score for each set of responses by comparing the responses provided by the user with the predictions of the VSR model to the same set of evaluation prompts; and
updating any portion of the set of lesson content based on the derived score for each of the set of responses.

2. The method of claim 1, wherein the user types specify any of: users with a hearing-impairment, users with a speech-impairment, users associated with another individual with any of the hearing-impairment and/or the speech-impairment, and users that have an interest in learning lip-reading skills for other communication purposes.

3. The method of claim 1, wherein the learning goals include any of:
understanding how to perform lip-reading; and
learning how to use tailored or silent speech.

4. The method of claim 1, further comprising:
processing each of the set of training instances in the content database to derive one or more attributes of each word in each training instance, one or more attributes including any of: an ambiguity of each word, a likelihood of each word being understood, a use frequency of each word, an age appropriateness of each word, and/or a relevancy of each word to the one or more interests of the user specified in the user profile, wherein the selection of the subset of the training instances are based on the one or more attributes of each word in each training instance.

5. The method of claim 1, wherein each of the set of evaluation prompts include a string of text with a request for the user to record a video on the user device to use tailored or silent speech to reproduce the string of text.

6. The method of claim 1, wherein each of the set of evaluation prompts include a video of a sample subject speaking without audio, and a request for the user to respond by accurately providing corresponding speech content.

7. The method of claim 1, further comprising:
responsive to determining that the derived score exceeds a threshold:
selecting, from the content database, an advanced subset of training instances based on a subset of training instances;
generating an advanced set of lesson content for the user that includes the advanced subset of training instances and an advanced set of evaluation prompts;
providing, to the user device, the advanced set of lesson content;
receiving, from the user device, a second set of responses to the advanced set of evaluation prompts;
deriving, via a second VSR-based evaluation model, a score by comparing the responses provided by the user with the predictions of the VSR model to the same set of evaluation prompts; and
further updating any portion of the set of lesson content based on the derived score for each additional set of responses.

8. The method of claim 1, wherein the subset of training instances include any of video, audio, text, and animations depicting one or more aspects of lip-reading or silent speech.

9. The method of claim 1, further comprising:
generating a training instance of the subset of training instances that includes an animation including a series of points providing a visual representation of facial features used to produce the speech content.

10. A computer-readable storage medium containing program instructions for a method being executed by an application, the application comprising code for one or more components that are called by the application during runtime, wherein execution of the program instructions by one or more processors of a computer system causes the one or more processors to perform steps comprising:
obtaining a user profile specific to a user;
selecting, from a content database, a subset of training instances based on the user profile;
generating a set of lesson content for the user that includes the subset of training instances and a set of evaluation prompts;
providing, to a user device, the set of lesson content;
receiving, from the user device, a set of responses to the set of evaluation prompts;
deriving, via a VSR-based evaluation model, a score for each set of responses by comparing the responses provided by the user with the predictions of the VSR model to the same set of evaluation prompts; and
updating any portion of the set of lesson content based on the derived score for each of the set of responses.

11. The computer-readable storage medium of claim 10, wherein the user profile specifies any of: a user type, an age of the user, one or more interests of the user, and a learning goal of the user, and wherein the subset of training instances are selected based at least on the learning goal of the user as specified in the user profile.

12. The computer-readable storage medium of claim 11, wherein the learning goals include any of:
understanding how to perform lip-reading; and
learning how to use tailored or silent speech.

13. The computer-readable storage medium of claim 10, wherein the instructions further cause the one or more processors to perform steps comprising:
generating, by a visual speech recognition (VSR) model, at least one training instance by:
obtaining a video source depicting a subject speaking; and
determining the speech content in the video source; and
adding the training instance to a content database that includes a set of training instances and corresponding audio output and/or text subtitles.

14. The computer-readable storage medium of claim 10, wherein each of the set of evaluation prompts include a string of text with a request for the user to record a video on the user device to use tailored or silent speech to reproduce the string of text.

15. The computer-readable storage medium of claim 10, wherein each of the set of evaluation prompts include a video of a sample subject speaking without audio, and a request for the user to respond by accurately providing corresponding speech content.

16. A computer-implemented method comprising:
obtaining a user profile specific to a user, the user profile specifying any of: a user type, an age of the user, one or more interests of the user, and a learning goal of the user;
generating at least one training instance by:
obtaining a video source depicting a subject speaking;
determining by a visual speech recognition (VSR) model, the speech content of the video source; and
processing each word of the speech content to derive one or more attributes of each word in each training instance;
storing the training instance to a content database that includes a set of training instances and corresponding audio output and/or text subtitles;
selecting, from the content database, a subset of training instances based at least on the learning goal of the user as specified in the user profile;
generating a set of evaluation prompts, wherein each of the set of evaluation prompts include any of:
a string of text with a request for the user to record a video on a user device to use tailored or silent speech to reproduce the string of text; and
a video of a sample subject speaking without audio, and a request for the user to respond by accurately providing corresponding speech content;
providing, to a user device, a set of lesson content for the user that includes the subset of training instances and a set of evaluation prompts;
receiving, from the user device, a set of responses to the set of evaluation prompts;
deriving, via a VSR-based evaluation model, a score for each set of responses by comparing the responses provided by the user with the predictions of the VSR model to the same set of evaluation prompts; and
updating any portion of the set of lesson content based on the derived score for each of the set of responses.

17. The computer-implemented method of claim 16, wherein the user types specify any of: users with a hearing-impairment, users with a speech-impairment, users associated with another individual with any of the hearing-impairment and/or the speech-impairment, and users that have an interest in learning lip-reading skills for other communication purposes.

18. The computer-implemented method of claim 16, wherein the learning goals include any of:
understanding how to perform lip-reading; and
learning how to use tailored or silent speech.

19. The computer-implemented method of claim 16, wherein the one or more attributes including any of: an ambiguity of each word, a likelihood of each word being understood, a use frequency of each word, an age appropriateness of each word, and/or a relevancy of each word to the one or more interests of the user specified in the user profile, wherein the selection of the subset of the training instances are based on the one or more attributes of each word in each training instance.

20. The computer-implemented method of claim 16, further comprising:
responsive to determining that the derived score exceeds a threshold:
selecting, from the content database, an advanced subset of training instances based on subset of training instances;
generating an advanced set of lesson content for the user that includes the advanced subset of training instances and an advanced set of evaluation prompts;
providing, to the user device, the advanced set of lesson content;
receiving, from the user device, a second set of responses to the advanced set of evaluation prompts;
deriving, via a second VSR-based evaluation model, a score by comparing the responses provided by the user with the predictions of the VSR model to the same set of evaluation prompts; and
further updating any portion of the set of lesson content based on the derived score based on any additional set of responses.

21. The computer-implemented method of claim 16, wherein the subset of training instances include any of video, audio, text, and animations depicting one or more aspects of lip-reading or silent speech.

22. The computer-implemented method of claim 16, further comprising:
generating a training instance of the subset of training instances that includes an animation including a series of points providing a visual representation of facial features used to produce the speech content.
